(19) United States
(12) Patent Application Publication
(10) Pub. No.: US 2008/0096443 A1
(43) Pub. Date: Apr. 24, 2008

(54) Terminal

(76) Inventors: Chieh-Min Kuan, Tu-Cheng City (TW); Shu-Man Chiang, Tu-Cheng City (TW); Tzu-Wei Chang, Tu-Cheng City (TW); Yeh-Ta Chien, Tu-Cheng City (TW); Chung-Hsin Huang, Tu-Cheng City (TW); Mei Chuan Yang, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/585,146

(22) Filed: Oct. 24, 2006

(51) Int. Cl. H01R 4/48

(52) U.S. Cl. 439/862

(57) ABSTRACT

A kind of terminal includes a base part, which is a planar shape. A connecting part extends from the back of the base part. A contact part extends from the front of the base part. The tip of the contact part forms a contact probe that has an arc surface. A pair of pass holes is defined on the left side and the right side of the base part. A region in the base part further protrudes upwards to form a lump as a press part and extends downwards to form an insertion part.

### BACKGROUND OF THE INVENTION

1. Field of the Invention

This invention generally relates to a terminal and, particularly, to a high frequency terminal.

2. The Related Art

Along with the electronic technology development, the high frequency terminal of electronic installation is used widely. Specially each kind of dexterous electronic products being published and the development along with recent years, the high frequency terminal is more important on these product applications.

The traditional terminal includes a contact part and a connecting part. The connecting part includes a transmitting part extending backward to the contact part, and a welding part extending backward to the transmitting part. The contact part includes a contact probe and a connecting arm.

When plural terminals assembled in the connector, the low value of the impedance Z generated between the plural terminals will result in low electrical conducting performance. So it is needed to increase the impedance Z between the plural terminals.

To overcome the shortcomings, the present invention tends to provide an improved terminal to mitigate and obviate the aforementioned problems.

### SUMMARY OF THE INVENTION

The present invention provides a kind of terminal, which includes a base part of planar shape. A connecting part extends from the back of the base part. A contact part extends from the front of the base part. The tip of the contact part forms a contact probe that has an arc surface. A pair of pass holes defined on the base part is apart by a region placed therebetween the pass holes. The region in the base part further protrudes upwards to form a lump as a press part and extends downwards to form an insertion part.

Through above structure, when plural terminals are assembled in a connector (not shown), the low value of the Z (denotes the impedance) generated between the plural terminals will result in low electrical conducting performance. So it is necessary to lower the C (denotes the capacitance) to increase the Z. According to the above formula, a means to lower the C is that reduce the S (denotes the square) of the base part. It causes the signal to transmit stably by the impedance Z increasing.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a terminal of the present invention;

FIG. 2 is a perspective view of another terminal of the present invention.

### DETAILED DESCRIPTION OF THE PREFERRED EMBODIMENT

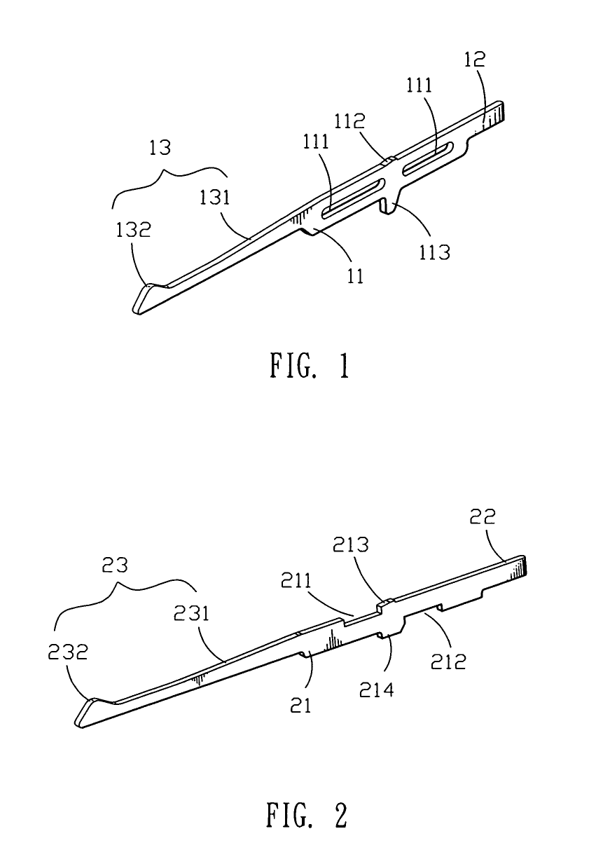

The terminal according to preferred embodiments of the present invention is illustrated in FIG. 1 and FIG. 2 and provides the functional arrangement and formation to increase the impedance Z.

Referring to FIG. 1, a terminal 1 includes a base part 11. The base part 11 extends backwards to form a connecting part 12, and extends forwards to form a contact part 13. A top surface of the base part 11, the connecting part 12 and the contact part 13 are in the same plane. A bottom surface of the base part 11 extends downwardly to make the base part 11 forming a rectangular planar shape. A tip of the contact part 13 forms a contact probe 132 that has an arc surface. A connecting arm 131 connects with the base part 11. A pair of pass holes 111 is defined in a left side and a right side of the base part 11 respectively. A region in the base part 11 further protrudes upwards to form a lump 112 as a press part and extends downwards to form an insertion part 113.

Referring to FIG. 2, a terminal 2 includes a base part 21. The base part 21 extends backwards to form a connecting part 22, and extends forwards to form a contact part 23. The top surface of the base part 11, the connecting part 22 and the contact part 23 are in the same plane. The bottom surface of the base part 21 extends downwardly to make the base part 21 forming a rectangular planar shape. The contact part 23 includes a contact probe 232 and a connecting arm 231. The contact probe 232 is a triangle. The connecting arm 231 connects with the base part 21. It has an altitudinal difference between the connecting arm 231 and the base part 21. A first nick 211 is defined on the upside of the base part 21. A second nick 212 is defined on the underside of the base part 21. A region in the base part 21 further protrudes upwards to form a lump 213 as a press part and extends downwards to form an insertion part 214.

According to formula

Z=(L/C)^{1/2}

C=εS/4πκd

### Wherein

Z: impedance
L: inductance
C: capacitance
S: square
d: distance

When plural terminals are assembled in a connector (not shown), the low value of the Z (denotes the impedance) generated between the plural terminals will result in the low electrical conducting performance. So it is necessary to lower the C (denotes the capacitance) to increase the Z. According to the above formula, a means to lower the C is that reduce the S (denotes the square) of the base part 11.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A terminal comprising:
a base part, which is a planar shape;
a connecting part, extending from the back of the base part; and
a contact part, extending from the front of the base part;
wherein the tip of the contact part forms a contact probe that has an arc surface, a pair of pass holes defined on the base part being apart by a region placed therebetween the pass holes, the region in the base part further protruding upwards to form a lump as a press part and extending downwards to form an insertion part.

2. The terminal as claimed in claim 1, wherein a top surface of the base part, the connecting part and the contact part are in the same plane.

3. The terminal as claimed in claim 1, wherein a bottom surface of the base part extends downwardly to make the base part forming a rectangular planar shape.
